(19) United States
(12) Patent Application Publication
(10) Pub. No.: US 2003/0051171 A1
(43) Pub. Date: Mar. 13, 2003

(54) Method and apparatus for user profiling

(75) Inventor: Siani Lynne Pearson, Bristol (GB)

Correspondence Address: HEWLETT-PACKARD COMPANY, Intellectual Property Administration, P.O. Box 272400, Fort Collins, CO, 80527-2400, US

(73) Assignee: HEWLETT-PACKARD COMPANY

(21) Appl. No.: 10/241,893

(22) Filed: Sep. 12, 2002

(30) Foreign Application Priority Data
Sep. 13, 2001 (GB) 0122048.2

(51) Int. Cl. H04L 9/00

(52) U.S. Cl. 713/201

(57) ABSTRACT

A user apparatus 10 forms a user identity such as in a trusted platform module 11, and captures at least one profile characteristic in a capture unit 12. An enquiry apparatus 20 sends a request to the user apparatus 10. In response, a profile unit 13 forms a user self-profile by combining the formed user identity with one or more selected profile characteristics of interest to the enquirer. Advantageously, the user profile is formed at the user apparatus, and sent on request to the remote enquiry apparatus. The user therefore maintains strong control of the user profile, and overhead such as data storage at the enquiry apparatus is decreased.

### FIELD OF THE INVENTION

The present invention relates in general to a method and apparatus for obtaining a profile of a user. In particular, the present invention relates to a method and apparatus that allows an enquirer at an enquiry apparatus to obtain a profile of a user at a remote user apparatus, across a networked computing system.

### DESCRIPTION OF THE RELATED ART

In the field of networked computing systems there is a strong desire to form a profile of a user. For example, in a commercial context a supplier desires to obtain a profile of each customer including characteristics such as the type, quantity, or frequency of product purchases. This customer profile then allows the supplier to offer incentives such as discounts appropriate to a customer's profile.

Typically, these customer profiles are held by the supplier, but give only a partial picture of the customer. Suppliers often desire to learn more about each customer, but a complete profile is only obtained by combining profiles held by many different suppliers. Information sharing between a large number of suppliers requires a high degree of co-operation, and impacts upon privacy and personal freedom of the customer. This commercial context is just one example, and there are many other situations where user profiling is desirable.

### SUMMARY OF THE INVENTION

An aim of the present invention is to provide a method and apparatus for obtaining a profile of a user. A preferred aim is to obtain a profile of a user at a user apparatus, the user profile being for use by an enquirer at a remote enquiry apparatus in a networked computing system. Here, a preferred aim is to obtain a user profile that is comprehensive, in that the user profile contains profile information of interest to the enquirer, whilst minimising a need for co-operation between different enquirers, and ideally minimising data overhead at the enquiry apparatus. Further, a preferred aim is to maintain privacy of the user, and ideally allow the user to maintain strong control over their profile information.

According to a first aspect of the present invention there is provided a method for obtaining a user profile, comprising the steps of: forming a user identity; capturing at least one profile characteristic; and combining the user identity and the captured profile characteristic to form a user self-profile.

This method is particularly suitable for use at a user apparatus.

Preferably, the step of forming a user identity comprises forming a trusted user identity. Conveniently, the trusted user identity is a cryptographic identity, preferably formed using an asymmetric encryption algorithm. As one example, a RSA algorithm (of the type designed by Rivest, Shamir and Adleman) is used to form a private identity key and public identity key pair. The public identity key is associated with a text label, and a certificate is formed signed by a trusted third party. Ideally, the trusted user identity is formed under a TCPA protocol defined by the Trusted Computing Platform Alliance, in which case the trusted third party is termed a privacy certifying authority. The trusted user identity allows an enquirer to trust the accuracy and reliability of the user identity.

In a first option, the user identity relates to the user's real identity. For example, the text label contains the user's real name. In another option, the user identity is anonymous and does not reveal the user's real identity. An association between real and anonymous user identities is known, for example, only by a trusted third party such as a privacy certifying authority. Preferably, the user identity is an anonymous trusted user identity, which allows an enquirer to trust that the user provides accurate and reliably identity information, without revealing the user's real identity.

Optionally, a plurality of user identities are formed, such that a different identity is used in different contexts, or different identities are used at different times in the same context. This allows the user to retain greater control over their user self-profile, by reducing the ability of enquirers to share information about the user.

The profile characteristics are captured in any suitable form, and the profile characteristics themselves are widely variable depending upon the context in which the user profile is to be employed.

In one example, profile characteristics are captured from user inputs, such as user responses to questions concerning the user's interests or preferences.

As a second example, profile characteristics are captured by recording user behaviour. For example, characteristics are based upon a history of activity on a user apparatus, such as by logging relevant events.

In a third example, profile characteristics are supplied from a separate computing platform and are captured at the user apparatus. Here, a profile characteristic is formed such as by a commercial supplier and supplied to the user apparatus to form part of the user self-profile. For example, the profile characteristic is formed as a cookie.

These and other methods for capturing profile characteristics can be employed alone, or in any combination. Preferably, a plurality of profile characteristics are captured, ideally pertaining to many different aspects of the user. The set of profile characteristics preferably represent a complete profile of the user, containing all characteristics of interest to each of a relevant group of enquirers.

Optionally, any one or more of the profile characteristics is verifiable. Verification allows an enquirer to place a relatively high degree of trust in the accuracy of the profile characteristic. For example, a profile characteristic is verified by a profile certifying authority. The profile certifying authority, if satisfied with the accuracy of the profile characteristic, provides an endorsement which is associated with a profile characteristic value to form a verified profile characteristic. The endorsement is suitably generated cryptographically, such as from a private key known only to the profile certifying authority and is verifiable using a public key made widely available by the profile certifying authority.

Suitably, a user self-profile is formed by combining the user identity and the at least one profile characteristic. In the preferred embodiments, a user self-profile is formed by selecting one amongst a plurality of available user identities, and by selecting one or more amongst a plurality of available profile characteristics. Preferably, the user self-profile is tailored to the needs of each enquirer, by selecting only a subset of the available profile characteristics which are of interest to the enquirer. Advantageously, the user does not release all of their profile characteristics to any one enquirer, and so maintains control of the complete user self-profile. By selecting amongst plural user identities, the user can maintain a high degree of privacy whilst releasing relevant profile characteristics of interest to enquirers.

Also according to the present invention there is provided a method of providing a user profile for use at an enquiry apparatus, the user profile representing a profile of a user at a user apparatus, the method comprising the steps of: at the user apparatus, forming a user identity and capturing one or more profile characteristics, and combining the user identity and the captured profile characteristics to form a user self-profile; and supplying the user self-profile from the user apparatus to the enquiry apparatus.

Preferably, the method comprises receiving a request at the user apparatus from the enquiry apparatus, and in response supplying the user self-profile including a subset of the captured profile characteristics.

Further, the method preferably comprises forming a trusted user identity that includes an identity label and a public identity, the public identity key being one part of a public key and private key pair. Here, ideally the identity label is an anonymous text label that does not reveal a real identity of the user.

Also according to the present invention there is provided a user apparatus for forming a user profile, comprising: an identity unit for forming a user identity; a capture unit for capturing one or more profile characteristics; and a profile unit for combining the user identity and at least one of the one or more profile characteristics, as a user self-profile.

Preferably, the user apparatus forms part of a trusted computing system. Suitably the user apparatus comprises a trusted platform module which acts as the identity unit and optionally as the capture unit and/or as the profile unit.

Further according to the present invention there is provided a user apparatus arranged for use by one or more users, and being coupleable in use to a networked computing system including an enquiry apparatus, the user apparatus comprising: a trusted platform module arranged to form one or more trusted user identities; a capture unit arranged to capture one or more profile characteristics representing characteristics of a user; and a profile unit arranged to form a user self-profile by combining a trusted user identity selected from amongst the one or more trusted user identities with a set of profile characteristics selected from amongst the one or more profile characteristics, such that the user self-profile is available to send from the user apparatus to an enquiry apparatus.

Preferably, the capture unit and the profile unit are each part of the trusted platform module.

Preferably, the trusted platform module is arranged to sign the user self-profile.

According to a second aspect of the present invention there is provided a method for obtaining a user profile, comprising the steps of: receiving a user self-profile comprising a user identity combined with one or more profile characteristics; checking the user identity of the user self-profile; and examining the one or more profile characteristics of the user self-profile.

This method is particularly suitable for use at an enquiry apparatus. The user self-profile is preferably received in response to a request sent from the enquiry apparatus to a user apparatus. Preferably, the request identifies the enquirer. Additionally or alternatively, the request preferably identifies one or more profile characteristics of interest to the enquirer.

Suitably, the enquirer performs a cryptographic check of the user identity. Where the user identity is a trusted user identity, suitably the enquirer checks a signature of a trusted third party. This check can simply be that the signature is present and in the expected format, or can involve more detailed investigation such as obtaining a signature checking key from the trusted third party. The enquirer may check the public identity key associated with the user identity label, such as by using this key to encrypt a message which can then only be read by a user possessing the corresponding private identity key. Hence, the enquirer may trust the identity of the user with a high degree of confidence.

The enquirer examines the one or more profile characteristics according to the nature of those characteristics. Where the profile characteristics are verifiable, preferably the enquirer verifies those profile characteristics by checking an endorsement. Suitably, the endorsement is checked using a public checking key made available by a profile certifying authority.

Also according to the present invention there is provided a method of obtaining a profile of a user of a user apparatus, such that the user profile is available for use at a remote enquiry apparatus, the method comprising the steps of: requesting a user profile by sending a request from the enquiry apparatus to the user apparatus; receiving a user profile from the user apparatus, the received user profile including a trusted user identity and one or more profile characteristics, the user profile having been formed at the user apparatus; and using the received user self-profile at the enquiry apparatus.

Preferably, the step of requesting a profile includes sending information identifying the enquiry apparatus, and information identifying profile characteristics of interest to the enquiry apparatus.

Preferably, the method comprises checking the trusted user identity.

Preferably, the method comprises verifying a profile characteristic by checking a verifying endorsement associated with the profile characteristic.

Further according to the present invention there is provided a enquiry apparatus for obtaining a profile of a user of a user apparatus, comprising: a request unit arranged to request a user self-profile from the user apparatus; a checking unit arranged to check a user identity of the user self-profile; and an examination unit arranged to examine one or more profile characteristics of the user self-profile.

Further still, according to the present invention there is provided an enquiry apparatus for use in a networked computer system, the enquiry apparatus for obtaining a profile of a user of a remote user apparatus, the enquiry apparatus comprising: request means arranged to send a profile request from the enquiry apparatus to the user apparatus; means arranged to receive a user self-profile from the user apparatus, the user self-profile including a trusted user identity and one or more profile characteristics, the user self-profile having been formed at the user apparatus; checking means arranged to check the trusted user identity such that the user identity is trusted by the enquiry apparatus; and an examination means arranged to examine the one or more profile characteristics.

Preferably, a profile characteristic amongst the one or more profile characteristics comprises a profile characteristic value and an associated endorsement, and the examination means is arranged to verify the profile characteristic using the endorsement.

Preferably, the endorsement has been generated cryptographically, and examination means is arranged to verify the cryptographically generated endorsement.

According to a further aspect of the present invention there is provided a method of obtaining a user profile, comprising the steps of: at a user apparatus, forming a user self-profile by combining a trusted user identity with a set of user profile characteristics; and at an enquiry apparatus remote from the user apparatus, requesting the user apparatus to supply the user self-profile, checking the trusted user identity, and examining the set of profile characteristics.

Further according to the present invention there is provided a networked computing system comprising: a user apparatus arranged to form a user self-profile by combining a set of captured profile characteristics with a trusted user identity; and an enquiry apparatus arranged to obtain a profile of a user by requesting the user self-profile from the user apparatus.

Preferably, one or more user apparatus and one or more enquiry apparatus form part of an open computing network, such as the internet. Here, since the computing network is open, it is particularly advantageous that the enquiry apparatus is able to trust the accuracy and reliability of a user self-profile formed at one of the one or more user apparatus.

According to yet another aspect of the present invention there is provided a user self-profile, comprising: a trusted user identity formed at a user apparatus; and at least one profile characteristic captured at the user apparatus.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 shows a preferred computing system including a user apparatus and several enquiry apparatus;

FIG. 2 shows an example user self-profile;

FIG. 3 shows a preferred method for forming a user self-profile; and

FIG. 4 shows a preferred method for obtaining a user self-profile.

### DETAILED DESCRIPTION OF THE INVENTION

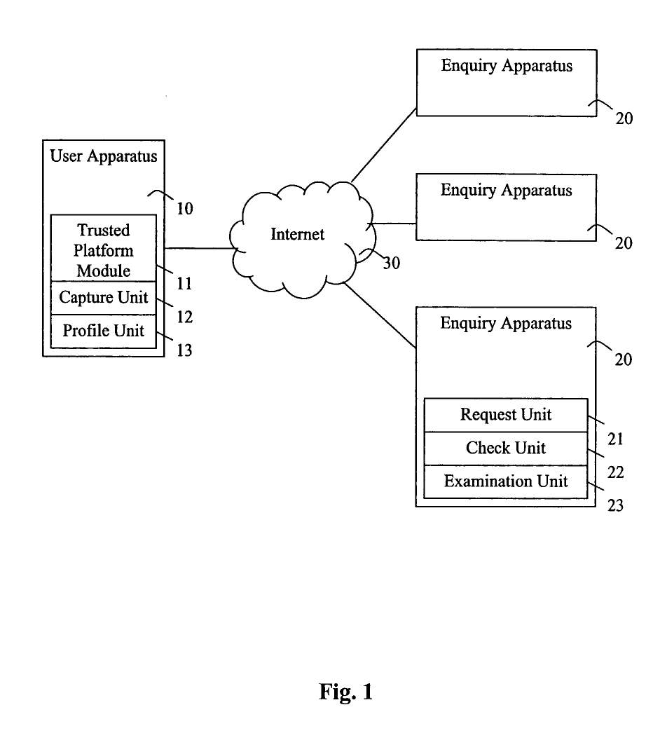

The preferred embodiments of the present invention will be described with reference to an example computing system shown in FIG. 1. The computing system comprises a user apparatus 10 coupled to, in this example, three separate enquiry apparatus 20 over a local computer network or a global computer network such as the internet 30, to form a networked computing system.

The user apparatus 10 may take any suitable form. In one embodiment, the user apparatus is readily portable and is sized to be carried by a user. For example, the user apparatus is a personal digital assistant (PDA), a cellular telephone, a laptop computer or a palmtop computer. In other embodiments the user apparatus 10 is relatively large and non-portable, such as a desktop computer. The user apparatus 10 can be a single apparatus, or can comprise separate parts.

The user apparatus 10 is intended for use by one or more individual users. For simplicity, the following description assumes that user apparatus 10 is intended for use by a single user. Also, the following description assumes that the user is the owner of the user apparatus, but the invention is also applicable to situations where the owner of the user apparatus allows access by one or more users.

Each enquiry apparatus 20 can take any suitable form. In one example, the enquiry apparatus is a relatively large and non-portable computing platform, such as a server. The server preferably performs many other functions, additional to acting as the enquiry apparatus, according to the context in which the enquiry apparatus is employed.

It is desired to form a profile of the user of the user apparatus 10, which is trusted by enquirers to be accurate and reliable. As one illustrative example context, the user apparatus is arranged to allow the user to purchase goods and services over the internet from a supplier who runs one of the enquiry apparatus 20. The supplier desires to obtain a profile of the user so that the supplier can offer the user incentives, such as discounts, tailored to the interests and preferences of the user. Hence, in the present invention, the user apparatus 10 creates a user self-profile, which is made available to the enquiry apparatus 20 of the supplier. However, this is just one example context, and the present invention is applicable also to many other practical situations.

In a particularly preferred embodiment of the invention, the user apparatus 10 is a trusted computing platform. Here, the user apparatus 10 comprises a trusted platform module 11 which allows enquiries to be made of the user apparatus 10 with a high degree of trust. More detailed background information concerning a trusted platform module 11 suitable for use in the preferred embodiments of the invention is available from the Trusting Computing Platform Alliance at www.trustedpc.org. See “TCPA Main Specification” version 1.0, dated Jan. 25, 2001.

In the presently preferred embodiments of the invention, the trusted platform module 11 comprises a trusted device. The trusted device is a hardware component such as an application specific integrated circuit (ASIC). Suitably, the trusted device is mounted within a tamper-resistant housing. The trusted device is coupled to other parts of the user apparatus and is suitably mounted on a motherboard of a main computing unit of the user apparatus 10.

The trusted platform module (TPM) 11 performs many functions. One function of the trusted platform module is to form an integrity metric representing the status and condition of the user apparatus, or at least the status and condition of selected parts of the user apparatus. The integrity metric is made available to a challenging enquirer who can then confirm that the user apparatus is in a trusted status and condition, by comparing the integrity metric against expected values. Such a user apparatus is then trusted to operate in a reliable and expected manner. For example, a trusted computing platform is trusted not to be subject to subversion such as by a virus, or by an unauthorised access, or by replication, or by impersonation.

In the preferred embodiments of the invention, the trusted platform module 11 functions to provide one or more trusted identities, which are used to identify the user of the user apparatus 10 to an enquirer.

Under the TCPA specification, the process for forming a trusted user identity comprises the steps of (a) establishing credentials of the user apparatus, which allows an enquirer to trust the status and condition of the user apparatus as a trusted computing platform, and (b) supplying these user apparatus credentials to a third party (known as a Privacy Certifying Authority or Privacy-CA) who in return certifies the trusted user identity. The Privacy-CA uses the supplied user apparatus credentials to verify that the user apparatus is a trusted computing platform with a genuine TPM, and hence is willing to certify to an identity of that platform. Optionally, the Privacy-CA may also check the real identity of the user, such as by checking a passport, driving licence, or other paper or electronic identity documents.

The trusted user identity is formed as a certificate comprising an identity label and a public identity key, and the certificate is signed by the Privacy-CA. Here, the identity-key is a cryptographic identity. Suitably, the Privacy-CA attests to the user identity by creating a credential that binds the identity-key to the identity-label and information about characteristics of the user apparatus. That credential can be presented to other entities, and allows the user of the user apparatus to prove that the identity belongs to a genuine TPM. The user apparatus 10 (strictly the TPM 11) can have as many or as few of these identities as the user wishes. The or each trusted user identity is conveniently stored by the trusted platform module 11, such as in a secure memory within the trusted device.

Advantageously, only the Privacy-CA can collate the credentials, or trace them back to the user. A user may therefore choose a Privacy-CA whose polices meet the user's privacy requirements. The user can himself act as a Privacy-CA if the user has sufficient credibility.

In a particularly preferred embodiment, the trusted user identity is anonymous. Here, the identity-label is, for example, an arbitrary text character string which does not reveal the real identity of the user. Such an anonymous trusted user identity allows the user a greater degree of privacy and increases willingness of the user to provide a detailed self-profile revealing characteristics of interest to an enquirer. Since the enquirer, such as a commercial supplier, is mainly interested in the user's profile characteristics, the real identity of the user is not at this stage particularly important. The anonymous trusted user identity functions simply as a convenient label. In the example context mentioned above, the anonymous trusted user identity is particularly advantageous at initial stages of a commercial transaction, such as where the user browses an online store.

In the preferred embodiment, the trusted platform module 11 supports a plurality of trusted user identities, and preferably a plurality of anonymous trusted user identities. One of these identities is selected when in an appropriate context. Here, the user is able to select one of many available identities each of which can be trusted by relevant enquirers. Advantageously, the user can retain a high degree of anonymity, and it is difficult for different enquirers to combine information about the user. Optionally, a selection amongst available identities is automatically rotated in a predetermined pattern, or picked randomly or pseudo-randomly, in order to further improve anonymity for the user.

In FIG. 1, the user apparatus 10 comprises a capture unit 12 for capturing profile characteristics. The capture unit 12 is conveniently part of the trusted platform module 11. That is, the trusted platform module 11 preferably also performs the function of the capture unit 12. Alternatively, the function of the capture unit 12 is performed by another part of the user apparatus such as a central computing unit in co-operation with a storage such as a disk storage unit.

The profile characteristics can take any suitable form and can be captured in any suitable manner. The profile characteristics are preferably captured from user inputs, such as by asking the user to fill out a questionnaire on screen. The questionnaire represents, for example, the user's preferences in fields such as sports, leisure, hobbies, financial matters or otherwise. Optionally, profile characteristics are captured by recording user behaviour at the user apparatus, such as by logging a history of websites visited or any other relevant event. Here, it is preferred for the user to actively control when such logging activities take place. As a third option, profile characteristics are captured at the user apparatus by downloading from a remote source. In the example context, the supplier creates a cookie which is downloaded to the user apparatus and is captured as one of the profile characteristics.

Also in FIG. 1, the user apparatus 10 comprises a profile unit 13 for forming a user self-profile based upon a user identity as established by the trusted platform module 11 and one or more profile characteristics captured by the capture unit 12. Optionally, the profile unit 13 is also part of the trusted platform module 11. In one embodiment, the profile unit 13 forms a user self-profile from a single identity and using all of the available profile characteristics. However, in other embodiments, the profile unit 13 forms a user self-profile according to a particular context. The or each user self-profile is stored and maintained on the user apparatus 10, or is formed dynamically such as in response to an enquiry.

Optionally, the user self-profile is signed by the trusted platform module 11, so that an enquirer is able to establish that the user self-profile has come from a secure source. Here, there is a chain of trust in that the enquirer trusts the trusted user identity because there is trust in the certifying authority (Privacy-CA), and trusts that the user self-profile has not be subverted because there is trust in the trusted platform module 11.

Each enquiry apparatus 20 suitably comprises a request unit 21, a checking unit 22, and an examination unit 23, amongst many other units which are not shown. Suitably, the enquiry apparatus is a computing platform such as a relatively powerful server. However, the enquiry apparatus could take any suitable form and in one option is configured similar to the user apparatus 10. It is possible that a single device is able to perform the functions of both the user apparatus 10 and an enquiry apparatus 20, preferably acting at times as a user apparatus and at other times as an enquiry apparatus.

In the example context mentioned above, the enquiry apparatus 20 is a server operated by a commercial supplier who offers goods through an online store to customers including the user of the user apparatus 10. At least in the initial stages of a transaction, it is desired to allow customers to browse the store, although it is also desired to tailor the online store for a particular customer, such as by offering links to products that might be of interest, or by offering discounts or other incentives. Suitably, the enquiry apparatus 20 is arranged to request a user self-profile from the user apparatus 10. In response to the user self-profile, the enquiry apparatus 20 is then able to establish a profile of the user. Advantageously, the user self-profile is used by the enquiry apparatus 20 to improve the online store for this customer. Also, the user self-profile avoids the need to hold large quantities of data about customers at the enquiry apparatus or related equipment run by the commercial supplier. For example, the user profile supplied to the enquiry apparatus 20 is deleted at the end of a customer visit to the online store, because the profile will be available again from the user apparatus 10 in a subsequent visit.

The request unit 21 of the enquiry apparatus 20 is arranged to issue a request to the user apparatus 10, conveniently in the form of a challenge to the trusted platform module 11. The trusted platform module 11 suitably provides a response, including the user self-profile.

The check unit 22 is arranged to check a user identity supplied as part of the user self-profile. As mentioned above this is preferably a trusted user identity and ideally an anonymous trusted user identity.

The examination unit 23 is arranged to examine the one or more profile characteristics supplied as part of the user self-profile. For example, in this context the profile characteristics show the user's product interests, screen layout preferences and shopping habits, either generally or specific to this supplier or a group of suppliers.

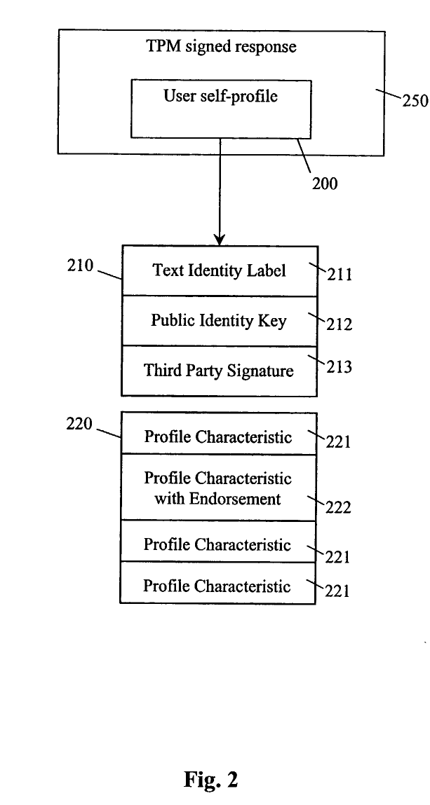

FIG. 2 shows an example user self-profile 200. The user self-profile 200 comprises a user identity 210 combined with one or more profile characteristics 220. The user identity 210 comprises a certificate signed by a Privacy-CA, the certificate including a text identity label 211 and a public identity key 212. Each of the profile characteristics 221 may take any suitable form, and a profile characteristic 221 is optionally verifiable with reference to an endorsement 222.

In use, the user self-profile 200 is preferably supplied within a response 250 signed by the trusted platform module 11. Advantageously, by providing the user self-profile 200 in a signed response 250, an enquirer has a high degree of confidence that the user self-profile has been formed in a trusted manner.

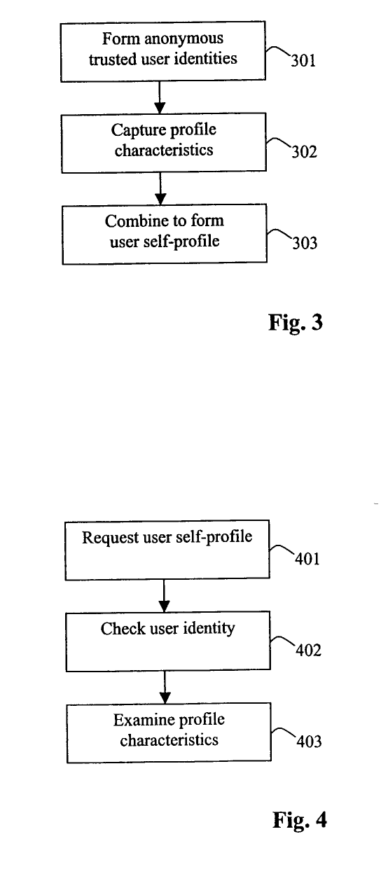

FIG. 3 shows a preferred method for obtaining a user self-profile.

In step 301 at least one user identity is formed. Preferably a plurality of anonymous trusted user identities are formed, using the trusted platform module 11.

In step 302, at least one and preferably many profile characteristics are captured.

In step 303 at least one of the user identities is selected and combined with one or more available profile characteristics, to form a user self-profile. Step 303 is suitably performed in response to a request from an enquirer.

FIG. 4 shows a method for enquiring such a user self-profile.

In step 401 the user self-profile is requested, suitably by sending a request from the enquiry apparatus 20 to the user apparatus 10. The request can be in the form of a challenge to the trusted platform module 11. The request suitably identifies the enquirer and identifies the profile characteristics of interest to the enquirer, either by explicitly naming the profile characteristics of interest, or by providing information which allows suitable profile characteristics to be determined.

In step 402 the user identity supplied in the user self-profile is checked. Firstly, the certificate from the Privacy-CA is checked for presence and format, and optionally the Privacy-CA's signature is checked such as by using a public key made available by the Privacy-CA. The user text identity label and public identity key are then available to the enquirer. The public identity key is used, for example, to check data signed by the user apparatus with a corresponding private identity key. The public key and private key suitably form a public key private key pair and are generated by an asymmetric encryption algorithm, such as RSA. Only the user apparatus validly holds the secret private identity key, and the enquirer may then trust that the user apparatus does indeed correspond to the claimed identity. Other options are available to check the user identity, such as encrypting data using the public identity key, which can only be decrypted by the valid user apparatus using the private identity key.

In step 403 the one or more profile characteristics supplied as part of the user self-profile are examined. If any of the characteristics are verifiable, then suitably a verifying endorsement is checked, such as by using a public key made available by a profile certifying authority.

A method and apparatus for user profiling have been described. In particular, a method and apparatus for obtaining a user self-profile and a method and apparatus for enquiring such a user self-profile have been described. The preferred method and apparatus have many advantages. The user maintains strong control over the self-profile and can choose to release only selected profile characteristics to a particular enquirer. The user self-profile can be anonymous to avoid releasing the user's real identity, but the user self-profile is trusted by an enquirer to be accurate and reliable. The user achieves a high degree of privacy, and only releases the self-profile when it is in the user's interests to do so. An enquirer benefits by obtaining potentially detailed profile characteristics about the user, and can then make highly-informed decisions when interacting with that user. Other features and advantages will be apparent from the description herein.

1. A method for obtaining a user profile, comprising the steps of:
forming a user identity;
capturing at least one profile characteristic; and
combining the user identity and the captured profile characteristic to form a user self-profile.

2. The method of claim 1, comprising cryptographically forming a trusted user identity.

3. The method of claim 2, wherein the trusted user identity comprises an identity label, and a public identity key.

4. The method of claim 3, wherein the trusted user identity comprises a certificate signed by a trusted third party.

5. The method of claim 2, wherein the trusted user identity is anonymous.

6. The method of claim 1, comprising forming a plurality of user identities.

7. The method of claim 1, comprising capturing a plurality of profile characteristics.

8. The method of claim 1, comprising capturing a profile characteristic by any one or more of (a) receiving data input by a user; (b) by recording user behaviour; or (c) by downloading a remotely formed data.

9. The method of claim 1, comprising forming at least one verifiable profile characteristic.

10. The method of claim 9, comprising obtaining an endorsement associated with a profile characteristic value to form the verifiable profile characteristic.

11. The method of claim 10, wherein the endorsement is generated cryptographically.

12. The method of claim 1, comprising forming the user self-profile dynamically in response to a request from a remote enquirer.

13. The method of claim 1, comprising forming a user self-profile by selecting one amongst a plurality of formed user identities, and selecting one or more amongst a plurality of captured profile characteristics.

14. The method of claim 13, comprising selecting the one user identity according to a context of an enquiry.

15. The method of claim 13, comprising selecting the one or more profile characteristics in response to information supplied by an enquirer.

16. A method of providing a user profile for use at an enquiry apparatus, the user profile representing a profile of a user at a user apparatus, the method comprising the steps of:
at the user apparatus, forming a user identity and capturing one or more profile characteristics, and combining the user identity and the captured profile characteristics to form a user self-profile; and
supplying the user self-profile from the user apparatus to the enquiry apparatus.

17. The method of claim 16, comprising receiving a request at the user apparatus from the enquiry apparatus, and in response supplying the user self-profile including a subset of the captured profile characteristics.

18. The method of claim 16, comprising forming a trusted user identity that includes an identity label and a public identity, the public identity key being one part of a public key and private key pair.

19. The method of claim 18, wherein the identity label is an anonymous text label that does not reveal a real identity of the user.

20. A user apparatus for forming a user profile, comprising:
an identity unit arranged to form at least one user identity;
a capture unit arranged to capture one or more profile characteristics; and
a profile unit arranged to combine the user identity and the profile characteristics as a user self-profile.

21. A user apparatus arranged for use by one or more users, and being coupleable in use to a networked computing system including an enquiry apparatus, the user apparatus comprising:
a trusted platform module arranged to form one or more trusted user identities;
a capture unit arranged to capture one or more profile characteristics representing characteristics of a user; and
a profile unit arranged to form a user self-profile by combining a trusted user identity selected from amongst the one or more trusted user identities with a set of profile characteristics selected from amongst the one or more profile characteristics, such that the user self-profile is available to send from the user apparatus to an enquiry apparatus.

22. The user apparatus of claim 21, wherein the capture unit and the profile unit are each part of the trusted platform module.

23. The user apparatus of claim 21, wherein the trusted platform module is arranged to sign the user self-profile.

24. A method for obtaining a user profile, comprising the steps of:
receiving a user self-profile comprising a user identity combined with one or more profile characteristics;
checking the user identity of the user self-profile; and
examining the one or more profile characteristics of the user self-profile.

25. A method of obtaining a profile of a user of a user apparatus, such that the user profile is available for use at a remote enquiry apparatus, the method comprising the steps of:
requesting a user profile by sending a request from the enquiry apparatus to the user apparatus;
receiving a user profile from the user apparatus, the received user profile including a trusted user identity and one or more profile characteristics, the user profile having been formed at the user apparatus; and
using the received user self-profile at the enquiry apparatus.

26. The method of claim 25, wherein the step of requesting a profile includes sending information identifying the enquiry apparatus, and information identifying profile characteristics of interest to the enquiry apparatus.

27. The method of claim 25, comprising checking the trusted user identity.

28. The method of claim 25, comprising verifying a profile characteristic by checking a verifying endorsement associated with the profile characteristic.

29. A enquiry apparatus for obtaining a profile of a user of a user apparatus, comprising:
a request unit arranged to request a user self-profile from the user apparatus;
a checking unit arranged to check a user identity of the user self-profile; and
an examination unit arranged to examine one or more profile characteristics of the user self-profile.

30. An enquiry apparatus for use in a networked computer system, the enquiry apparatus for obtaining a profile of a user of a remote user apparatus, the enquiry apparatus comprising:
request means arranged to send a profile request from the enquiry apparatus to the user apparatus;
means arranged to receive a user self-profile from the user apparatus, the user self-profile including a trusted user identity and one or more profile characteristics, the user self-profile having been formed at the user apparatus;
checking means arranged to check the trusted user identity such that the user identity is trusted by the enquiry apparatus; and
an examination means arranged to examine the one or more profile characteristics.

31. The apparatus of claim 30, wherein a profile characteristic amongst the one or more profile characteristics comprises a profile characteristic value and an associated endorsement, and the examination means is arranged to verify the profile characteristic using the endorsement.

32. The apparatus of claim 31, wherein the endorsement has been generated cryptographically, and examination means is arranged to verify the cryptographically generated endorsement.

33. A method of obtaining a user profile, comprising the steps of:
at a user apparatus, forming a user self-profile by combining a trusted user identity with a set of user profile characteristics; and
at an enquiry apparatus remote from the user apparatus, requesting the user apparatus to supply the user self-profile, checking the trusted user identity, and examining the set of profile characteristics.

34. A networked computing system comprising:
a user apparatus arranged to form a user self-profile by combining a set of captured profile characteristics with a trusted user identity; and
an enquiry apparatus arranged to obtain a profile of a user by requesting the user self-profile from the user apparatus.

35. A user profile, comprising:
a trusted user identity formed at a user apparatus; and
at least one profile characteristic captured at the user apparatus.
